(19) United States
(12) Patent Application Publication
(10) Pub. No.: US 2009/0080916 A1
(43) Pub. Date: Mar. 26, 2009

(54) XEROGRAPHIC COPYING APPARATUS AND METHOD OF CHECKING TROUBLE POINT IN THE SAME AND COMPUTER PROGRAM

(75) Inventor: Norikazu Ochiai, Izu-shi (JP)

Correspondence Address: AMIN, TUROCY & CALVIN, LLP, 127 Public Square, 57th Floor, Key Tower, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 11/674,018

(22) Filed: Feb. 12, 2007

(51) Int. Cl. G03G 21/14; G03G 15/00

(52) U.S. Cl. 399/43; 399/81; 399/55

(57) ABSTRACT

In a method of checking a trouble point in a xerographic copying apparatus of the invention, a sequence code is selected from a plurality of sequence codes to distinguish a plurality of sequences to stop an operation of the xerographic copying apparatus in any one process of a plurality of print processing processes for print output of a sheet, an operation of a photoconductor in a state where toner is attached is stopped in any one process among the plurality of print processing processes in accordance with the sequence corresponding to the selected sequence code, and any one trouble point is checked, and therefore, the point where a poor image is generated is suitably grasped.

### BACKGROUND OF THE INVENTION

1. Field of the Invention

The present invention relates to a xerographic copying apparatus suitable for use in, for example, a xerographic type printer or an MFP (Multi Function Peripheral) apparatus, a method of checking a trouble point which can be when a person who services the apparatus checks the apparatus, and a computer program which can be used in the apparatus.

2. Description of the Related Art

In the case where a defect in an image or the like occurs in a machine, it is necessary to know which part is in trouble. Hitherto, with respect to a technique to diagnose the failure of a machine, there is proposed an image forming apparatus provided with image forming means for sequentially executing a plurality of operations in a self-diagnosis mode (for example, JP-A-2005-77690). Besides, there is also proposed a failure diagnosis apparatus to diagnose the failure of a drive mechanism unit, the defect of operation and the like (for example, JP-A-2005-33559).

For that purpose, for example, in order to confirm whether an image on a photoconductor is normal, the operator who performs services, such as a check of a state of a machine, repeatedly changes a timing when the rotation of the photoconductor is stopped in conformity to a timing when an image is put on a photoconductor. The operator sensuously measures how many seconds have passed since a certain sound was generated, and by this, he or she knows that the image is just put on the photoconductor. Hitherto, in the state where the image is put on the photoconductor, the operator suddenly turns off the power supply of the machine to stop the rotation of the photoconductor, and the operator confirms the image on the photoconductor, on a transfer belt or on a paper.

However, in the case where the operator who does not participate in the design of the machine checks the state of the machine at the place of a customer, it takes a considerable time for the operator to measure the timing when the photoconductor is stopped. Besides, when the operator suddenly turns off the power supply of the machine of the customer, there occurs a phenomenon in which carrier is adsorbed on the surface of the photoconductor, and this destroys the machine or produces an image having a defect.

### SUMMARY OF THE INVENTION

It is an object of the present invention to provide a xerographic copying apparatus in which a sequence to stop an operation of a photoconductor is generated, and an operator selects a code described in the sequence to stop the operation of the photoconductor, so that a defect of an image is prevented from occurring on the photoconductor, on a transfer belt, or on a paper before fixation.

In an aspect of the present invention, a xerographic copying apparatus includes a developing unit, a transfer unit, a fixing unit, a sequence code display unit to display a sequence code to distinguish each sequence from a holding unit to hold a computer program describing sequences to stop an operation of the xerographic copying apparatus in print processing processes of a sheet including a developing process, a transfer process and a fixing process, a sequence code selection unit to select the sequence code displayed on the sequence code display unit, and an operation stop processing unit to stop an operation of a photoconductor in a state where toner is attached in any one process of the plurality of print processing processes in accordance with the sequence corresponding to the selected sequence code and described in the computer program held in the holding unit.

### DESCRIPTION OF THE DRAWINGS

FIG. 1 is a schematic structure view of, as a four-pass machine, a xerographic copying apparatus according to an embodiment of the invention.

FIG. 2 is a block diagram of a xerographic copying apparatus according to an embodiment of the invention.

FIG. 3 is a schematic structural view of, as a one-pass machine, a xerographic copying apparatus according to an embodiment of the invention.

FIGS. 4A to 4E are views each showing a display example of a display unit of a xerographic copying apparatus according to an embodiment of the invention.

FIG. 5A is a time chart of speed of a drive motor of a photoconductor of a xerographic copying apparatus according to an embodiment of the invention.

FIG. 5B is a time chart of potential of a charging unit of the xerographic copying apparatus according to the embodiment of the invention.

FIG. 5C is a time chart of applied voltage to a developing unit of the xerographic copying apparatus according to the embodiment of the invention.

### DETAILED DESCRIPTION OF THE INVENTION

Throughout this description, the embodiments and examples shown should be considered as exemplars, rather than limitations on the apparatus and methods of the present invention.

Hereinafter, embodiments of the invention will be described in detail taking the attached drawings as examples.

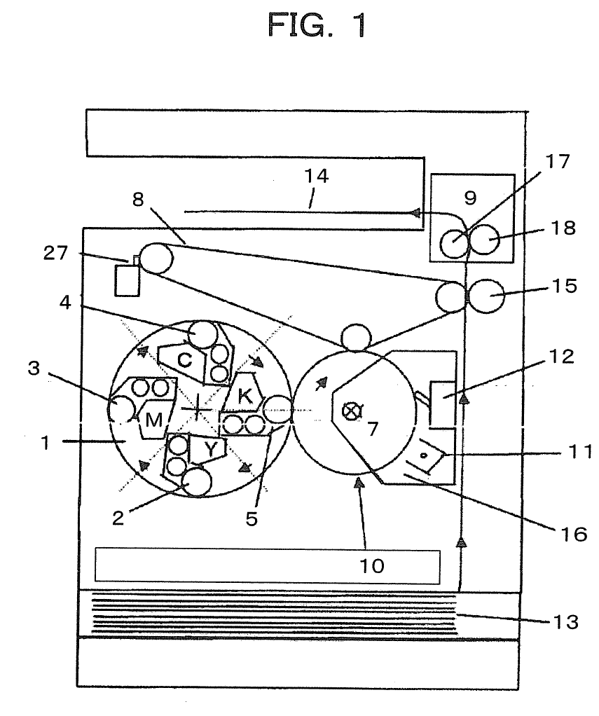

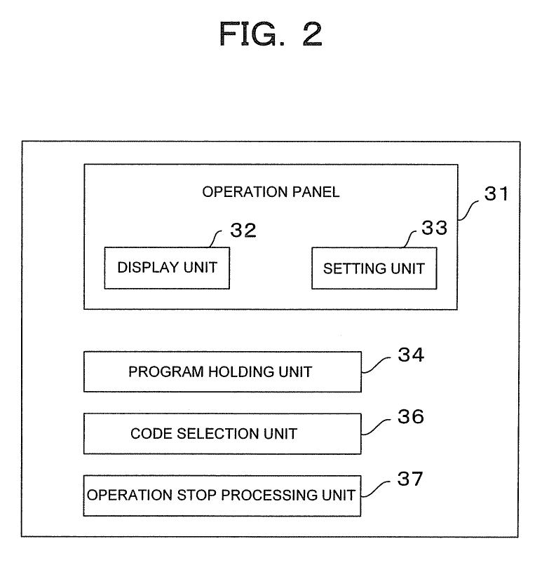

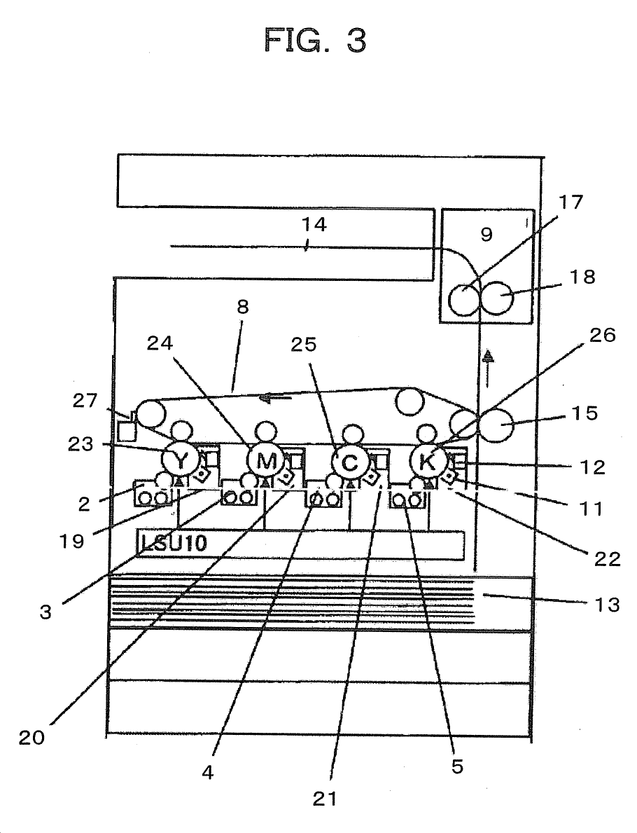

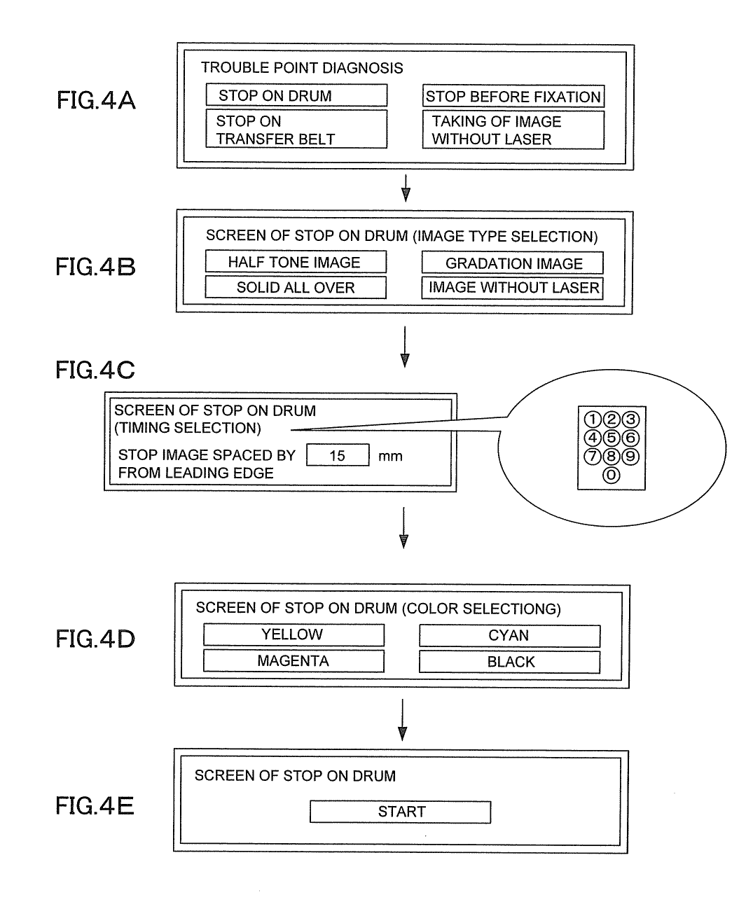

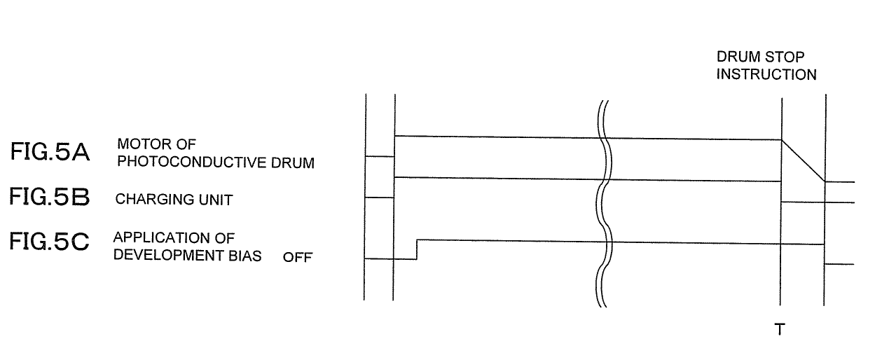

Incidentally, in the respective drawings, the same portions are denoted by the same reference numerals and their duplicate description will be omitted. FIG. 1 is a schematic structure view of, as a four-pass machine, a xerographic copying apparatus according to an embodiment of the invention, FIG. 2 is a block diagram of a xerographic copying apparatus according to an embodiment of the invention, FIG. 3 is a schematic structural view of, as a one-pass machine, a xerographic copying apparatus according to an embodiment of the invention, FIGS. 4A to 4E are views each showing a display example of a display unit of a xerographic copying apparatus according to an embodiment of the invention, FIG. 5A is a time chart of speed of a drive motor of a photoconductor of a xerographic copying apparatus according to an embodiment of the invention, FIG. 5B is a time chart of potential of a charging unit of the xerographic copying apparatus according to the embodiment of the invention, and FIG. 5C is a time chart of applied voltage to a developing unit of the xerographic copying apparatus according to the embodiment of the invention.

A xerographic copying apparatus of an embodiment of the invention is applied to a printer, a copying machine, a FAX or an MFP apparatus having these functions. As shown in FIG. 1, the xerographic copying apparatus of the embodiment includes a revolver 1, an yellow developing unit 2, a magenta developing unit 3, a cyan developing unit 4, a black developing unit 5, a photoconductive drum 7, an intermediate transfer body 8, a fixing unit (fixing device, fixing unit) 9, an LSU (Laser Scanner Unit) 10, a charging unit 11, a cleaning device 12, a cassette 13, a sheet (or printed paper) 14, a secondary transfer roller 15, a drum unit 16, and an intermediate transfer body cleaning device 27.

The revolver 1 includes therein the yellow developing unit 2, the magenta developing unit 3, the cyan developing unit 4, and the black developing unit 5. When the revolver 1 makes one rotation, printing is performed four times.

The photoconductive drum 7 is a photoconductor, and is, together with the drum unit 16, supported by bearings. The photoconductive drum 7 is rotation-driven by a not-shown motor.

The LSU 10 is a laser beam output unit to irradiate a laser beam to the photoconductive drum 7. Besides, the machine, that is, the xerographic copying apparatus may be provided with a mechanism to shield the laser beam irradiated from the LSU 10.

The drum unit 16 is provided with the charging unit 11 to charge the photoconductive drum 7 to a suitable potential, and the cleaning device 12 as a cleaning unit to clean toner on the photoconductive drum 7.

Each of the yellow developing unit 2, the magenta developing unit 3, the cyan developing unit 4, and the black developing unit 5 is a developing unit to generate a latent image on the photoconductive drum and to attach toner to the latent image. The developing units 2 to 5 include a toner attachment unit to attach the toner to the latent image generated by the laser beam on the charged photoconductive drum.

The intermediate transfer body 8 is an intermediate transfer belt to which the toner attached to the latent image is attached. The four-color toner images formed on the surface of the photoconductive drum 7 are transferred to the intermediate transfer body 8. A transfer unit to transfer the toner attached to the latent image to the sheet is constructed of the intermediate transfer body 8 and the secondary transfer roller 15.

The intermediate transfer body cleaning device 27 is for removing the toner or the like on the intermediate transfer body 8.

The fixing unit 9 is for fixing the toner transferred to the sheet 14 to the sheet 14. The fixing unit 9 includes a heat roller 17 to transport the sheet 14 in a state where heat is applied to the sheet 14 and a press roller 18 to transport the sheet 14 in a state where pressure is applied to the sheet 14. The fixing unit 9 may be constructed to be detachable from the machine.

By this, the sheet 14 in the cassette 13 is pulled up by the rotation of the secondary transfer roller 15, and in conjunction with this, the paper on which the toner image is fixed is transported by the rotation of the heat roller 17 and the press roller 18 in the fixing unit 9.

Besides, the operation of the machine is automatically stopped in the middle of printing by the instruction of the operator. As shown in FIG. 2, the machine includes a program holding unit 34, an operation panel 31, a code selection unit 36, and an operation stop processing unit 37, and an after-mentioned computer program is executed under the control of a not-shown CPU (Central Processing Unit).

The program holding unit 34 is a holding unit, and holds a computer program describing a plurality of sequences to stop an operation of the machine in any one process among a plurality of print processing processes for print output of the sheet 14, including at least processes in the developing units 2 to 5, a process in the transfer unit, and a process in the fixing unit 9.

Specifically, this computer program describes the sequences to stop the operation of the photoconductive drum 7 in the process in the charging unit 11, the process in the LSU 10, and the process in the toner attachment unit.

Besides, the computer program describes the sequence to stop the operation of the photoconductive drum 7 in the attachment process of toner on the intermediate transfer body 8. The computer program describes also the sequence to stop the operation of the photoconductive drum 7 in the process in the cleaning device 12.

The program holding unit 34 may be provided in the inside of the machine, or may be structured to be detachable from the machine. The program holding unit 34 may be provided outside the machine, and the machine can also read the computer program held in the external program holding unit 34. As the program holding unit 34, a storage medium, such as a ROM, hard disk, floppy disk, CD, DVD or flash memory, can be used.

The operation panel 31 includes a display unit 32 and a setting unit 33. The display unit 32 is a sequence code display unit to display one or a plurality of sequence codes to distinguish the respective sequences described in the computer program. The setting unit 33 is for operation of an after-mentioned distance data setting unit, a pitch length data setting unit, and a bias timing delay unit. A touch panel, a touch key, a button or the like can be used for the operation panel 31, the display unit 32 and the setting unit 33.

The code selection unit 36 is a sequence code selection unit to select a sequence code instructed by the operator from the one or the plurality of sequence codes displayed on the display unit 32.

The operation stop processing unit 37 is for stopping the operation of the photoconductive drum 7 in a state where toner is attached in any one process among the plurality of print processing processes in accordance with a sequence corresponding to the sequence code selected by the code selection unit 36 and described in the computer program held in the program holding unit 34.

The processes of generating an image in the machine using the xerographic system will be described on the basis of the foregoing structure.

In the machine, the photoconductive drum 7 is made to adsorb the electric charge by the charging unit 11, and is charged to a potential of, for example, −600 v. Thereafter, the laser beam is irradiated from the LSU 10 to the photoconductive drum 7, and the potential at a place of the surface of the photoconductive drum 7 where the beam is irradiated is reduced to, for example, −150 v.

Next, the yellow developing unit 2, the magenta developing unit 3, the cyan developing unit 4, or the black developing unit 5 disposed at a position where it comes in contact with the photoconductive drum 7 will be described. The black developing unit 5 is disposed at the position opposite to the photoconductive drum 7. The laser beam is irradiated to the photoconductive drum 7, and when a portion whose potential is reduced to, for example, −150 v reaches the position where it comes in contact with the black developing unit 5, the potential of a Mg (magenta) roller of the black developing unit 5 is made to, for example, −450 v.

In this state, when the portion where the potential of the photoconductive drum 7 is reduced to −150 v reaches, the toner on the Mg roller is attached by the potential difference to the portion of the photoconductive drum 7 to which the laser is irradiated. A toner attachment process in each of the yellow developing unit 2, the magenta developing unit 3, and the cyan developing unit 4 is similar to the toner attachment process in the black developing unit 5.

Next, the photoconductive drum 7 is rotated, and the toner on the photoconductive drum 7 is moved to the position opposite to the intermediate transfer body 8. The toner on the photoconductive drum 7 is moved to the intermediate transfer body 8 at this position by the potential difference. The toner not moved even by this movement is collected by the cleaning device 12. The toner put on the intermediate transfer body 8 is moved by the potential difference at the position opposite to the secondary transfer roller 15 to the sheet 14 transported between the secondary transfer roller 15 and the intermediate transfer body 8. The toner not moved to the sheet 14 from the intermediate transfer body 8 even by this movement is collected by the intermediate transfer body cleaning device 27.

The toner put on the sheet 14 is transported to the fixing unit 9, and the transported toner is fixed to the sheet 14 by the heat and pressure of the heat roller 17 and the press roller 18. In the case where the four-pass machine shown in FIG. 1 is used, first, the yellow developing unit 2 is disposed at the opposite position to the photoconductive drum 7 by the rotation of the revolver 1. The yellow toner put on the photoconductive drum 7 is moved onto the intermediate transfer body 8.

Next, the revolver 1 is rotated, and the magenta toner is moved from the magenta developing unit 3 to the photoconductive drum 7. The magenta toner on the photoconductive drum 7 is put on the intermediate transfer body 8.

Next, the revolver 1 is rotated, and the cyan toner is moved from the cyan developing unit 4 to the photoconductive drum 7. The cyan toner on the photoconductive drum 7 is put on the intermediate transfer body 8.

Finally, the revolver 1 is rotated, and the black toner is moved from the black developing unit 5 to the photoconductive drum 7. The black toner on the photoconductive drum 7 is put on the intermediate transfer body 8. At this time, the machine puts the four color toners on the intermediate transfer body 8 in turn. The four color toners are overlapped with each other on the intermediate transfer body 8. The intermediate transfer body 8 on which the four colors are overlapped is transported. The four-color toner images are transferred to the sheet 14 by the secondary transfer roller 15.

The xerographic copying apparatus of the embodiment may be constructed as a one-pass machine. As shown in FIG. 3, in the machine as the one-pass machine, four developing units 2 to 5 are disposed in one line along the transport direction of an intermediate transfer body 8. The machine includes, for respective colors, photoconductive drums 23 to 26, drum units 19 to 22, the developing units 2 to 5, a cleaning device 12, and a charging unit 11. The respective photoconductive drums 23 to 26 are charged, and latent images are generated by laser beams (indicated by arrows) of an LUS 10. Toners of the respective colors are put on the latent images of the respective photoconductive drums 23 to 26 by the respective developing units 2 to 5. The four-color toner images are put on the intermediate transfer body 8 in order of yellow, magenta, cyan and black. The toners which can not be moved from the respective photoconductive drums 23 to 26 to the intermediate transfer body 8 are collected by the cleaning device 12. A sheet 14 is transported between the intermediate transfer body 8 and the secondary transfer roller 15, and the toners are transferred to the sheet 14. Thereafter, the toners on the sheet 14 are fixed in a fixing unit 9.

The machine is constructed such that in a copying machine, a printer or a FAX in which a defect of an image occurs, the operator can easily grasp that the defect occurs in which part. While printing is being performed in a part such as the developing units 2 to 5, the intermediate transfer body 8 or the fixing unit 9, the operator stops the operation of the machine halfway. In order that the operator confirms whether the operations in the respective parts before the operation of the machine was stopped are normal, the computer program installed in the machine causes the machine to perform the processing to stop the operation halfway. When the operator uses the operation panel 31 to select a sequence code in the computer program, the machine stops the operation in the middle of printing.

In the case where the xerographic type machine is checked, the operator checks whether an image on the photoconductive drum is normal, and next, checks whether an image on the transfer belt is normal, and next, checks whether a state on a paper after secondary transfer (transfer to the paper) is normal, and finally, checks whether an image after fixation is normal. At this time, the operation of the machine is stopped when the image is put on each of the parts so that the operator can perform the respective checks. In the case where the operator checks, for example, the photoconductive drum, the operator takes out the drum unit of the photoconductive drum, and checks the image on the photoconductive drum taken out.

The operator stops the operation of the machine in the state where the image is put on the photoconductive drum, and in the case where it is determined that an abnormality occurs on the photoconductive drum, the machine is checked in a manner as described below.

1. Since there is a possibility that a defect occurs in the LSU (laser) 10, the operator takes an analog image. The taking of the analog image is performed such that the laser beam is not irradiated or the laser beam is shielded, and the charging voltage is reduced, so that the potential on the photoconductive drum becomes lower than the development potential. Slight light emission of the laser beam can be avoided by the shielding of the laser beam. After the operator sets the potential on the photoconductive drum 7 to become lower than the development bias, the operator causes the machine to perform printing.

As a result of the printing, in the case where a poor image is produced also in the analog image on the photoconductive drum, it is found that something other than the part for exposure is in trouble.

As a result of the printing, in the case where a poor image is not produced in the analog image, it is found that the LSU (laser) is in trouble.

2. Next, a way of checking the charging unit will be described.

Since there is a possibility that the charging unit 11 is in trouble, the operator replaces the charging unit 11 mounted to the machine with a preliminary charging unit for exchange. After this replacement, the operator stops the operation of the machine in a state where an image is put on the photoconductive drum 7, and checks whether the image on the photoconductive drum 7 is changed between before and after the exchange.

3. Next, since there is a possibility that the developing units 2 to 5 are in trouble, the operator replaces the mounted developing units 2 to 5 with other developing units for exchange. After the exchange, similarly to the above-described process 2, the operator stops the operation of the machine, and checks the presence or absence of change of the image on the photoconductor.

4. In addition to the LSU 10, the charging unit 11, and the developing units 2 to 5, the operator exchange the cleaning device 12, an electricity removing LED or the photoconductive drum 7 with the equivalent mounted to the machine. After this exchange, the operator stops the operation of the machine similarly to the above-described processes 2 and 3, and checks the presence or absence of change of the image on the photoconductor.

These processes 1, 2, 3 and 4 are executed and a check is made as to which portion of the machine is in trouble.

Next, an operation method of making a diagnosis of an occurrence place of a defective image according to an embodiment will be described with reference to FIG. 4A to FIG. 4E.

First, while depressing a specified button on the operation panel 31, the operator turns on the power supply of the machine, and shifts the machine into a failure diagnosis mode. A screen for diagnosing an occurrence place of a poor image is displayed on the display unit 32 of the operation panel 31 as shown in FIG. 4A.

The operator selects any one touch key among a plurality of touch keys displayed on the display unit 32. For example, when “stop on drum” is selected, a plurality of different touch keys as shown in FIG. 4B are displayed on the display unit 32. For example, when “halftone image” is selected, as shown in FIG. 4C, a screen for input of a numerical value is displayed. The operator inputs a numerical value equivalent to a grasped distance by input to the numeric keypad on the operation panel 31.

When a numeric value, for example, 15 mm from the leading edge of an image is inputted by the operator, as shown in FIG. 4D, a touch key for selecting four colors is displayed. The operator selects a color corresponding to any one photoconductor among the four developing units 2 to 5, which the operator wishes to stop. When the color is selected, a screen for confirmation (FIG. 4E) is displayed, and the operator depresses a start key. By this, the operation of the machine is started, and the photoconductor which the operator tries to stop is stopped at a timing when a portion spaced by 15 mm from the leading edge of the image is put on the photoconductive drum 7. The operator confirms the image on the photoconductive drum 7.

As stated above, in the method of checking the trouble point in the xerographic copying apparatus according to the embodiment, the machine displays the one or the plurality of sequence codes, the instructed sequence code of the displayed one or the plurality of sequence codes is selected, and in accordance with a sequence corresponding to the selected sequence code and described in the computer program from the program holding unit 34, the operation of the photoconductive drum 7 in the state where toner is attached is stopped in any one process among the plurality of print processing processes, and a trouble point is checked.

Here, in the case where the trouble point is found, in the machine, a part corresponding to the trouble point is exchanged.

Besides, in the xerographic copying apparatus of the embodiment, the computer program of the invention is executed. The computer program is for causing the CPU or LSI to execute a step of displaying one or a plurality of sequence codes to distinguish a plurality of sequences to stop the operation of the machine in any one process, a step of selecting an instructed sequence code among the displayed sequence codes, and a step of, in accordance with a sequence corresponding to the selected sequence code, performing a processing to stop, in any one process, the operation of the photoconductive drum 7 in a state where toner is attached. The computer program is held in the storage medium, so that the storage, transport, selling and the like of the computer program for checking a trouble point can be easily performed.

As stated above, the operator selects the sequence or the code on the operation panel 31, so that the operation to stop the operation of the machine halfway or the operation for taking the analog image is performed. By this, the trouble point of the machine is specified. When the operator selects any one code, the machine is shifted into the mode which corresponds to the selected code and in which the operation of the machine is stopped halfway. The operator takes an image obtained as a result of printing in the mode and checks the image.

Next, for the check of the state where an image is put on the transfer belt, the operator stops the printing when the image is put on the transfer belt. At this stop operation, after the operator confirms that there is no poor image on the photoconductor, the operator checks the surface of the transfer belt. By this, it is found whether the image before movement to the transfer belt is normal and whether the poor image has been produced on the transfer belt.

Then, after the operator exchanges the transfer belt, unless the poor image is produced, it is found that the defect exists in the originally mounted transfer belt unit, and the operator has only to perform the processing of exchanging the transfer belt unit.

Next, the operator checks the photoconductive drum 7 and the transfer belt. In the case where a poor image is not produced, the operator checks an image after the secondary transfer. After the sheet 14 passes the secondary transfer roller 15, the operator checks the image before the fixation process. At this time, the operator prints the poor image first.

The check of the image after the secondary transfer will be further described.

The xerographic copying apparatus of the embodiment includes a distance data setting unit including the operation panel 31, CPU, ROM, RAM and the like. The distance data setting unit sets distance data for stopping the operation of the photoconductive drum 7 at a timing when a toner image located at a place spaced by a specified distance from the leading edge of a toner image to be transferred is put on the intermediate transfer body 8 or the sheet 14. In the case where four developing units are provided for respective colors, the distance data setting unit can set the distance data for each of the colors.

By this, in the case where it has been found that the poor image is produced at a place spaced by a distance in mm from the leading edge of the image, the operator operates the operation panel 31 to start the operation of stopping the paper transport when the position of the poor image reaches between the secondary transfer roller 15 and the fixing unit 9. Specifically, the operator uses the button on the operation panel 31 and the like to send instruction data to stop the operation of the transport after the paper is transported by the distance in mm after the secondary transfer. By this instruction, the machine calculates in accordance with the sequence, and stops the transfer belt at the position corresponding to the instructed distance.

In other words, in the method of checking the trouble point in the xerographic copying apparatus according to the embodiment, the data is set for the machine to realize the timing when the toner image located at the place spaced by the specified distance is put on the photoconductive drum 7, the intermediate transfer body 8 or the sheet 14 before the machine stops the operation of the photoconductive drum 7 in any one process. The machine causes the photoconductive drum 7 to operate for the time corresponding to the set distance data, and stops the operation of the photoconductive drum 7 at the timing when the toner image is put on the photoconductive drum 7, the intermediate transfer body 8 or the sheet 14, and the trouble point is checked.

Next, the operator checks whether the poor portion of the image occurs at an interval equal to the pitch of one period of the rotation of the secondary transfer roller 15. In more detail, the xerographic copying apparatus of the embodiment includes also a not-shown pitch length data setting unit. On the secondary transfer roller 15, the pitch length data setting unit sets pitch length data for stopping the transport of the sheet 14 at the timing when a portion of the sheet 14 spaced by the peripheral length along the side of the secondary transfer roller 15, that is, the distance equivalent to the pitch is positioned at a place between the secondary transfer roller 15 and the fixing unit 9.

By this, the machine stops the transport of the sheet 14 so that the portion of the sheet 14 spaced by the distance equivalent to the pitch of the secondary transfer roller 15 is positioned between the secondary transfer roller 15 and the fixing unit 9. By this check, when a defect occurs in the secondary transfer roller 15, the operator exchanges the secondary transfer roller unit.

Finally, when the respective checks up to the secondary transfer roller unit indicate that a defect does not occur, the operator exchanges the fixing unit. After the fixing unit is exchanged, the operator causes the machine to perform a printing operation, and determines whether the fixing unit is in trouble.

In the embodiment, in the case where the processing along the sequence to stop the operation of the machine at each position is executed, as shown in FIG. 5A, after the stop is instructed to the photoconductive drum at time T, the motor can not be abruptly stopped. The motor is rotated by the inertia. Thus, in the case where application of high voltages to all parts are simply stopped simultaneously, the surface of the photoconductive drum charged to a high potential is opposite to the developing units 2 to 5 (FIG. 5B) to which the application of the high voltage is stopped. In this case, the photoconductive drum attracts the carrier. When this is performed repeatedly, the photoconductive drum is damaged. Accordingly, during the period after the stop instruction to the motor of the photoconductive drum and before the stop of the motor, it becomes necessary to delay the stop of application of the high voltage to the developing units 2 to 5 (FIG. 5C).

Thus, the xerographic copying apparatus of the embodiment includes also a bias timing delay unit (not shown) to delay the stop of application of development bias to the developing units 2 to 5 during the period after the issuance of the stop instruction to the motor of rotating the photoconductive drum 7 and before the stop of the motor. Accordingly, when the photoconductive drum 7 is completely stopped, the development bias is turned off.

Besides, in the embodiment, after the operation of the machine in which the image is put on the transfer belt is stopped, when the operator again checks the machine, performs another stop operation of the machine, or returns the machine to the normal operation, the operator closes the front cover, and then causes the secondary transfer roller 15 to be subjected to the cleaning operation, and completes the cleaning of the secondary transfer roller 15. Thus, the computer program held in the program holding unit 34 describes the sequence to clean the secondary transfer roller 15 when the machine is started up after the operation of the photoconductive drum 7 is stopped in any one process.

In the embodiment, also in the case where the poor image occurs at the position spaced by a distance in mm from the leading edge of the print area of the sheet 14, the operator operates the operation panel 31. Specifically, the operator uses a button on the operation panel 31 and the like to specify distance data to indicate when the photoconductive drum is stopped after a poor image at a position spaced by a distance in mm from the leading edge of an image is printed at a specified position on the photoconductive drum. That is, it is determined that the photoconductive drum is stopped after a time equivalent to the distance in mm between the leading edge of the print area and the stop position has passed. Then, after the rotating photoconductive drum is stopped, the operator checks the state on the photoconductive drum.

Similarly, in the embodiment, the operator uses the button on the operation panel 31 and the like to specify distance data to indicate that the transfer belt is stopped when a poor image at a position spaced by a distance in mm from the leading edge of an image reaches a specified position on the transfer belt. That is, also with respect to the image after the secondary transfer, it is specified that the secondary transfer roller 15 is stopped at a position where the poor image spaced by the distance in mm from the leading edge of the image reaches between the secondary transfer and the fixation. The secondary transfer roller 15 is stopped at the position.

In the embodiment, in the case where the photoconductive drum 7 on which the image is put is stopped, and in the case where the transfer belt on which the image is put is stopped, it is not necessary to put the image on the paper, and therefore, the operator does not cause the sheet 14 to be transported in the inside of the machine, but causes the sequence of printing to be executed, and by this, the image can be put on the photoconductor or the transfer belt. Accordingly, the operator's labor of removing the sheet later can be omitted. Besides, the computer program held in the program holding unit 34 previously describes the sequence to execute the respective operations in the process in the developing units 2 to 5 and the process in the intermediate transfer body 8 independently of each of the process in the transfer unit and the process in the fixing unit 9.

In the embodiment, in the case where the operator confirms an image positioned after the secondary transfer and before the fixation, when the distance of processing from the secondary transfer to the fixation is short, the image on the sheet 14 passes the fixing unit 9. Accordingly, it is not determined whether the poor image is caused by the secondary transfer or by the fixation. Thus, after detaching the fixing unit 9, the operator causes the machine to print. At this time, since the fixing unit 9 is detached, the operator performs setting by the operation panel 31 so that the temperature control of the fixation is not checked in the sequence.

Besides, in the embodiment, the operator can set the function of sensing the passing of the sheet 14 in the fixing unit 9 to be ineffective. Thus, the computer program held in the program holding unit 34 describes the sequence for causing the operation of transporting another sheet for taking a toner image to be executed independently of the process in the fixing unit 9.

By this, after the fixing unit 9 is detached from the machine, since the printing becomes possible, the operator can check the image on the sheet 14 before the fixation.

In the embodiment, in the case where the operator checks the LSU (laser) 10, even if the laser beam is stopped when the operator takes an analog image, the laser beam slightly emits light. Thus, in order to completely eliminate the influence of the laser beam, the operator provides the machine with a shutter as a mechanism to shield the laser beam irradiated from the LSU 10. Thus, the computer program held in the program holding unit 34 describes a sequence for causing an operation of reducing the potential in the charging unit of charging the photoconductive drum 7 to a specified potential to be executed so that the potential on the photoconductive drum 7 becomes lower than the development potential.

Besides, the invention can be used also for adjustment. In the method of checking the trouble point in the xerographic copying apparatus according to the embodiment, the machine causes the transfer unit to transfer toner to the sheet 14, and the voltage of the transfer in the transfer unit is adjusted based on an image on the sheet 14 to which the toner is transferred.

In more detail, for a service performed for each customer, the condition of transfer is matched with the paper used by the customer. In this case, the operator stops the operation of the machine after the transfer to the paper. Specifically, the operator selects a mode for adjusting the transfer. In the case where this adjustment is performed, the operator variously changes the voltage for the transfer, and causes the machine to print a mark such as a lateral band. The operator determines which voltage is suitable by seeing the image after the transfer. Then, in the adjustment mode of the transfer, the operator operates the operation panel 31 to input a numerical value so that the suitable voltage is obtained. The machine is set so that the proper transfer condition matching the paper used by the customer is obtained, and the suitable operation is performed.

As described above, according to the invention, a defective part of the MFP apparatus or the like can be specified, and the waiting time of a customer can be shortened by the quick handling. Further, the operator can check and adjust the machine without a manual.

Although exemplary embodiments of the present invention have been shown and described, it will be apparent to those having ordinary skill in the art that a number of changes, modifications, or alterations to the invention as described herein may be made, none of which depart from the spirit of the present invention. All such changes, modifications, and alterations should therefore be seen as within the scope of the present invention.

What is claimed is:

1. A xerographic copying apparatus comprising:
a developing unit configured to generate a latent image on a photoconductor and to attach toner to the latent image;
a transfer unit configured to transfer the toner attached to the latent image to a sheet;
a fixing unit configured to fix the toner transferred to the sheet to the sheet;
a sequence code display unit configured to display one or a plurality of sequence codes to distinguish each sequence from a holding unit configured to hold a computer program describing a plurality of sequences to stop an operation of the xerographic copying apparatus in print processing processes of the sheet including a process in the developing unit, a process in the transfer unit, and a process in the fixing unit;
a sequence code selection unit configured to select an instructed sequence code from the sequence codes displayed on the sequence code display unit; and
an operation stop processing unit configured to stop an operation of the photoconductor in a state where toner is attached in any one process of the plurality of print processing processes in accordance with the sequence corresponding to the sequence code selected by the sequence code selection unit and described in the computer program held in the holding unit.

2. The xerographic copying apparatus of claim 1, wherein
the developing unit includes a charging unit configured to charge the photoconductor to a specified potential, a laser beam output unit configured to irradiate a laser beam to the photoconductor, and a toner attachment unit configured to attach the toner to the latent image generated by the laser beam on the charged photoconductor, and
the computer program held in the holding unit describes a sequence for stopping the operation of the photoconductor in any one process among a process in the charging unit, a process in the laser beam output unit, and a process in the toner attachment unit.

3. The xerographic copying apparatus of claim 1, further comprising an intermediate transfer body to which the toner attached to the latent image is attached, wherein
the computer program held by the holding unit describes a sequence for stopping the operation of the photoconductor in a process of attaching the toner to the intermediate transfer body.

4. The xerographic copying apparatus of claim 1, further comprising a cleaning unit configured to clean the toner on the photoconductor, wherein
the computer program held by the holding unit describes a sequence for stopping the operation of the photoconductor in a process in the cleaning unit.

5. The xerographic copying apparatus of claim 1, further comprising a distance data setting unit configured to set distance data to stop the operation of the photoconductor at a timing when a toner image spaced by a specified distance from a leading edge of a toner image to be transferred is put on any one of the photoconductor, an intermediate transfer body to which the toner attached to the latent image is attached, and the sheet to which the toner on the intermediate transfer body is fixed.

6. The xerographic copying apparatus of claim 5, further comprising a bias timing delay unit configured to delay a stop of application of a development bias to the developing unit during a period after issuance of a stop instruction to a motor of rotating the photoconductor and before a stop of the motor.

7. The xerographic copying apparatus of claim 5, wherein
in a case where a plurality of the developing units are provided for respective colors, the distance data setting unit sets the distance data for the respective colors.

8. The xerographic copying apparatus of claim 1, further comprising
a pitch length data setting unit configured to set pitch length data to stop transport of the sheet at a timing when a place of the sheet spaced by a distance equivalent to a peripheral length along a side of the secondary transfer roller, on the secondary transfer roller provided to be opposite to an intermediate transfer body to which the toner attached to the latent image is attached, is positioned at a place between the secondary transfer roller and the fixing unit.

9. The xerographic copying apparatus of claim 1, wherein
the transfer unit can adjust a transfer voltage based on an image on the sheet to which the toner is transferred.

10. The xerographic copying apparatus of claim 1, wherein
the computer program held by the holding unit describes a sequence for causing a secondary transfer roller, which is provided to be opposite to an intermediate transfer body to which the toner attached to the latent image is attached, to be executed when the xerographic copying apparatus is started after the operation of the photoconductor is stopped in any one process of the plurality of print processing processes.

11. The xerographic copying apparatus of claim 1, wherein
the computer program held by the holding unit describes a sequence for causing each operation in a process in the developing unit and a process in an intermediate transfer body to which the toner attached to the latent image is attached in the process in the developing unit to be executed independently of the process in the transfer unit and the process in the fixing unit.

12. The xerographic copying apparatus of claim 1, wherein
the fixing unit is detachable from the xerographic copying apparatus, and
the computer program held by the holding unit describes a sequence for causing, in a case where the fixing unit is detached from the xerographic copying apparatus, an operation of transporting another sheet for taking a toner image to be executed independently of the process in the fixing unit.

13. The xerographic copying apparatus of claim 1, further comprising
a mechanism to shield a laser beam irradiated from a laser beam output unit, wherein
the computer program held by the holding unit describes a sequence for causing an operation of reducing a potential in a charging unit of charging the photoconductor to a specified potential to be executed to make the potential on the photoconductor lower than a development potential.

14. A method of checking a trouble point in a xerographic copying apparatus including a developing unit to generate a latent image on a photoconductor and to attach toner to the latent image, a transfer unit to transfer the toner attached to the latent image to a sheet, and a fixing unit to fix the toner transferred to the sheet to the sheet, comprising the steps of:
displaying, by the xerographic copying apparatus, one or a plurality of sequence codes to distinguish a plurality of sequences to stop an operation of the xerographic copying apparatus in any one process among print processing processes of the sheet including a process in the developing unit, a process in the transfer unit, and a process in the fixing unit;
selecting, by the xerographic copying apparatus, an instructed sequence code from the one or the plurality of sequence codes displayed;
stopping, by the xerographic copying apparatus, an operation of the photoconductor in a state where the toner is attached in any one process of the plurality of print processing processes in accordance with the sequence corresponding to the selected sequence code from a holding unit to hold a computer program describing the plurality of sequences; and
checking, by the xerographic copying apparatus, any one trouble point.

15. The method of checking the trouble point in the xerographic copying apparatus of claim 14, further comprising the steps of:
before the step of, by the xerographic copying apparatus, stopping the operation of the photoconductor in any one process among the plurality of print processing processes, setting, by the xerographic copying apparatus, distance data to stop the operation of the photoconductor at a timing when a toner image spaced by a specified distance from a leading edge of a toner image to be transferred is put on any one of the photoconductor, an intermediate transfer body to which the toner attached to the latent image is attached, and the sheet to which the toner on the intermediate transfer body is fixed;
causing, by the xerographic copying apparatus, the photoconductor to operate for a time equivalent to the set distance data;
stopping, by the xerographic copying apparatus, the operation of the photoconductor at a timing when the toner image is put on one of the photoconductor, the intermediate transfer body and the sheet; and
checking, by the xerographic copying apparatus, any one trouble point.

16. The method of checking the trouble point in the xerographic copying apparatus of claim 14, further comprising the step of:
in a case where any one trouble point is found, exchanging, by the xerographic copying apparatus, a part corresponding to the trouble point.

17. The method of checking the trouble point in the xerographic copying apparatus of claim 14, further comprising the steps of:
causing, by the xerographic copying apparatus, the transfer unit to transfer the toner to the sheet; and
adjusting, by the xerographic copying apparatus, a transfer voltage in the transfer unit based on an image on the sheet to which the toner is transferred.

18. A computer program for causing a xerographic copying apparatus including a developing unit to generate a latent image on a photoconductor and to attach toner to the latent image, a transfer unit to transfer the toner attached to the latent image to a sheet, and a fixing unit to fix the toner transferred to the sheet to the sheet, to function as:
a step of causing the xerographic copying apparatus to display one or a plurality of sequence codes to distinguish a plurality of sequences to stop an operation of the xerographic copying apparatus in any one process among a plurality of print processing processes for print output of the sheet, including at least a process in the developing unit, a process in the transfer unit, and a process in the fixing unit;
a step of causing the xerographic copying apparatus to select an instructed sequence code from the one or the plurality of sequence codes displayed; and
a step of causing the xerographic copying apparatus to perform a processing of stopping an operation of the photoconductor in a state where the toner is attached in any one process of the plurality of print processing processes in accordance with the sequence corresponding to the selected instructed sequence code.
